(19) United States
(12) Patent Application Publication
(10) Pub. No.: US 2004/0104940 A1
(43) Pub. Date: Jun. 3, 2004

(54) Method for moving a graphical pointer on a computer display

(76) Inventor: Fabrizio Giacomelli, Roma (IT)

Correspondence Address: Messrs, Young & Thomson, 745 South 23rd Street, Arlington, VA, 22202, US

(21) Appl. No.: 10/466,914

(22) PCT Filed: Jan. 17, 2002
(86) PCT No.: PCT/IT02/00025

(30) Foreign Application Priority Data
Jan. 24, 2001 (IT) RM2001A000032

(51) Int. Cl. G09G 5/00

(52) U.S. Cl. 345/769

(57) ABSTRACT

The invention relates to a method for moving a graphical pointer, controlled by suitable pointing electro-mechanical means, such as a mouse, for instance, on a working area of a computer display, including one or more selectable graphical items, such as graphical push-buttons or textual boxes, such method allowing to speedily move the graphical pointer in simple and accurate way among the various selectable graphical items, the results being particularly advantageous when large working areas are involved. This invention relates also to the instruments needed to perform the method as well as to the apparatuses performing the method.

This invention relates to a method for moving a graphical pointer, controlled by suitable pointing electro-mechanical means, such as a mouse, for instance, on a working area of a computer display, including one or more selectable graphical items, such as graphical push-buttons or textual boxes, such method allowing to speedily move the graphical pointer in simple and accurate way among the various selectable graphical items, the results being particularly advantageous when large working areas are involved.

This invention relates also to the instruments needed to perform the method as well as to the apparatuses performing the method.

It is known that the processors or computers are provided with a display screen that enables the users to check their interactions with the computer itself. In particular, the computers are provided with a program assembly, so-called operation system, that allows an optimised management of the electronic resources of the concerned computer in a quite transparent way to the user, by receiving data and/or instructions, via a data entering device, such as a keyboard, and by furnishing data and/or instruction requests by means of the screen.

At present, most of the computers are provided with an operation system including a graphical user interface or GUI, upon which a graphical pointer is movable under control of pointing electro-mechanical means in order to transmit the required control signal to the computer, to control the position and/or the displacement of the graphical pointer, as well as one or more selection signals.

The presently most popular GUI's include a so-called “window” interface, in which each window is an interaction interface of a specific application program including, in addition to data visualised and not modifiable by the user, some selectable graphical items, which allow the user to interact with the application program itself. By way of exemplification, but not by way of limitation, such selectable graphical items can be command menu bars, window sliding bars, graphical push-buttons, selectable option boxes or checkboxes, sets of alternatively selectable option boxes, textboxes, ipertextual connections or links, icons.

The various windows of a GUI can be alternatively enabled to interaction and, when they are disabled, they are graphically represented by a corresponding icon. When the interaction with an application program is enabled, the related window becomes the working area by which the user can interact with the program by using the graphical pointer (besides the keyboard). In particular, the selection of a selectable graphical item within an active window, that forms the working area, occurs by superimposing the graphical pointer on the selectable graphical item and by contemporaneously generating a corresponding selection signal by using said pointing electro-mechanical means.

A computer provided with an operation system having a window GUI will be explicitly referred to in the following description. It should be understood, however, that the method according to this invention and the related instruments and apparatuses can be also applied to graphical user interfaces including graphical items selectable by means of a graphical pointer controlled by pointing electro-mechanical means.

The pointing electro-mechanical means comprise a pointing device, connected to the computer, which generates control signals to control the position and/or the displacement of said graphical pointer, by generating suitable control signals, and which is adapted to generate one or more selection signals. In particular, the user is enabled to control the position and/or the displacement of the graphical pointer on the display screen by a two-dimensional or three-dimensional material manoeuvre of said device.

The pointing devices that control the position of said graphical pointer comprise an electronic tablet upon which the user manoeuvres a movable item adapted to electronically interact with said tablet. The device transmits signals representing the position of the contact point between the movable item and the tablet to the computer. In particular, each point of the tablet corresponds to a point of the screen under a one to one relationship. When said movable item is dragged on the tablet, the graphical pointer moves along the screen points corresponding to the points of the contact path between the movable item and the tablet.

These pointing devices directly controlling the position of the graphical pointer have the shortcoming that they are cumbersome, in order to achieve a sufficient control accuracy. Furthermore, this causes a certain inconvenience of use.

Aiming at eliminating such shortcoming, pointer devices have been developed to control the displacement of the graphical pointer by performing a control of its position with respect to its starting movement point.

The most popular among the pointer devices based upon a “relative” control is the one commonly known as “rotating ball mouse” or simply “mouse”. It is formed by a casing, manoeuvrable with a hand, including a small ball seated therein and partially protruding from its bottom surface. The movement of the mouse upon a surface, such as a suitable panel or mouse pad, causes a corresponding rotation of the ball in its seat, where suitable transducers generate signals representing the distance and the direction of the two-dimensional path followed by the mouse. The mouse is connected to the computer by a suitable cable and is provided with one or more push-buttons, usually two or three, corresponding selection signals being generated by pressing said push-buttons.

In other words, the events occurring in the mouse are such that the linear displacements of the graphical pointer on the screen are controlled by the movements of the mouse in directions (x,y) on the mouse pad.

The term “linear displacement” means that a linear dependence exists between the two movements: if the mouse moves upwardly by y centimetres, the graphical pointer proportionally moves upwardly by y elemental graphical points or pixel according to the following relationship:

$$y = \frac{y}{k}$$

where k is a suitable coefficient linked to the speed parameter of the graphical pointer, said parameter being settable by the user.

All above said operation takes place regardless of the contents of the window in which said graphical pointer is being moved, in particular, regardless of the selectable graphical item.

The pointer devices similar to mouses operate in similar way; such as the infrared mouse or tailless mouse, in which the cable based transmission of signals to the computer is substituted by an infrared transmission, or even an optical mouse, in which the signals representing the two-dimensional path followed by the mouse are generated by LED and/or photocell devices. Also some pointer devices applicable to portable computers are similar to mouses, such as the track point and the touch pad; comprising a cylindrical rod inserted into a keyboard, one end of which can be pulled in various directions, and a small planar surface electronically responsive to touch of an object, respectively.

All these devices have the drawback that they cause a noticeable fatigue in the hand and in the wrist of the user manoeuvring them, up to causing severe inflammations, such as the carpal tunnel syndrome.

Some approaches have been proposed to solve such problems.

Among these solutions, we can mention the trackball, that comprises a small ball housed in a stationary seat, from which a portion of the ball protrudes upwardly in order to allow its manoeuvring operations or the foot controlled mouse (that, on the other hand, does not appear to be easy to be used), or the upper wheel mouse or Intellimouse which substantially is formed by a mouse provided with an upper wheel designed to be operated by a finger of the user so as to let the window vertically scroll.

Anyhow, all above mentioned pointer devices have the drawback that they need a long operation time to move the graphical pointer across a large window, even when it is not desired to look-up data and information visualised therein, but it is only desired to position the graphical pointer on a selectable graphical item in order to select it.

The approach proposed by this invention is to be considered in this context.

It is an object of this invention, therefore, to provide a method for moving a graphical pointer controlled by a pointing electro-mechanical means, such as a mouse, for instance, on a working area of a computer display, including one or more selectable graphical items, such method enabling the graphical pointer to be speedily moved in simple and accurate way among the various selectable graphical items.

It is a further object of this invention to provide the instruments needed to perform the method and the apparatuses performing the method itself.

It is specific subject matter of this invention a method for moving a graphical pointer on a working area of the display screen of a computer, said working area including one or more selectable graphical items, said graphical pointer being controlled by pointing electro-mechanical means adapted to generate at least a control signal for controlling the position and/or the movement of said graphical pointer as well as one or more selection signals and to transmit said signals to said computer, the selection of a graphical item being performed by generating a first selection signal by said pointing electro-mechanical means and being carried out when said graphical pointer is superimposed on said selectable graphical item, the method being characterised in that it includes the following steps:

A. acquiring a displacement start event from at least one control signal generated by said pointing electro-mechanical means;

B. storing a starting position of the graphical pointer on the screen, which coincides with the position taken at the occurrence of said displacement start event;

C. moving said graphical pointer proportionally to said at least one control signal generated by said pointing electro-mechanical means, storing a second position of said graphic pointer on said screen, and calculating a vector representing the displacement of said graphic pointer on the screen from said starting position to said second position;

A. defining, within said within said working area, an attraction area for the graphic pointer that is symmetrical with respect said displacement vector;

B. determining an assembly of selectable graphic items included in said attraction area;

C. checking that said assembly of selectable graphic items is not void;

D. when the result of said step F is positive, locating a target graphic item among the selectable graphic items of said assembly, according to a geometric proximity criterium to said second position of the graphic pointer, and moving said graphic pointer to a final position superimposed on said target graphic item; and

E. returning to performing said step A.

According to this invention said step C. can include the following sub-steps in the following order:

C1.1. acquiring a displacement end event from at least one control signal generated by said pointing electro-mechanical means;

C1.2. storing the second position of the graphical pointer on the screen as the one coinciding with the position taken at the occurrence of said displacement end event; and

C1.3. computing the vector representative of the displacement of the graphical pointer on the screen from the starting position to the second position.

Still according to this invention said step C can also include the following sub-steps in the following order:

C1.4. checking whether the distance between said second position and said initial position is smaller than a minimum distance, and

C1.5. when the result of sub-step C1.4 is positive, return to performing step A.

Further according to this invention said sub-step C1.4 can be subsequent to said sub-step C1.3 or said sub-step C1.4 can be subsequent to said sub-step C1.2 and said sub-step C1.3 can be subsequent to said sub-step C1.5.

Alternatively, according to this invention, said step C can also include the following sub-steps in the following order:

C2.1. allowing an inactivity pause to elapse;

C2.2. storing a current position of the graphical pointer on the screen, that coincides with the position taken at the end of said pause;

C2.3. checking whether the distance between the current position and the starting position is smaller than a minimum distance;

C2.4. when the result of said sub-step C2.3 is positive, checking said at least one control signal generated by said pointing electro-mechanical means, and, when said at least one control signal corresponds to a movement of said graphical pointer, returning to performing said sub-step C2.1, or, when said at least one control signal does not correspond to a movement of said graphical pointer, returning to performing said step A,

C2.5. when the result of said sub-step C2.3 is negative, storing said second position of the graphical pointer on the screen as the one coinciding with the current position,

said step C also including the following sub-step:

C2.6. computing the vector representative of the displacement of the graphical pointer on the screen from the starting position to the second position.

Still according to this invention, said sub-step C2.6 can be subsequent to said sub-steps C2.4 and C2.5 or said sub-step C2.6 can be subsequent to said sub-step C2.2 and precedent to said sub-step C2.3.

Again according to this invention, the attraction area for the graphical pointer as defined in said step D is included within a planar angle having a width no greater than 180°, the apex of which coincides with the starting position of the graphical pointer and the bisecting line of which lies on the vector representative of the displacement of said graphical pointer.

Preferably, according to this invention, said planar angle has a width no greater than 90°, more preferably no greater than 60° and still more preferably no greater than 45°.

Further according to this invention, the attraction area for said graphical pointer as defined in step D can be furnished by the intersection of an isosceles triangle with said working area or of a circular sector with said working area or of said planar angle with said working area.

Preferably according to this invention, said step E determines said assembly of selectable graphical items as the assembly of all selectable graphical items included in said working area.

Still according to this invention, said step G locates said target graphical item among the graphical items of said assembly as that graphical item having minimum distance from said second position of the graphical item.

Alternatively according to this invention, said step G can include the following sub-steps:

G2.1. for each selectable graphical item included in said assembly,

determining the point of said selectable graphical item nearest to the second position of said graphical pointer, and

calculating the distance of said point nearest to the second position of the graphical pointer;

G2.2. locating said target graphical item among the graphical items of said assembly as that graphical item having minimum distance as calculated in said sub-step G2.1.

Still according to a further embodiment of the method of this invention, said step G can include the following sub-steps:

G3.1. for each selectable graphical item included in said assembly,

calculating a connection vector that starts from the initial position of the graphical pointer and arrives at a point of the considered graphical item,

calculating the absolute value α° of the width of the angle defined by the vector representing the displacement of said graphical pointer and by said connection vector,

calculating a first ratio α°/Ω° between said absolute value α° and a first constant value Ω°,

calculating the distance d of said point from the second position of said graphical pointer,

calculating a second ratio d/D between said distance d and a second constant value D,

calculating the sum

$$S = \frac{{α}^{°}}{{Ω}^{°}} + \frac{d}{D}$$

of said first ratio and said second ratio,

G3.2. locating said target graphical item among the graphical items of said assembly as that graphical item having minimum sum S as calculated in said sub-step G3.1.

Further according to this invention, the arrival point of said connection vector as calculated in said sub-step G3.1 can be the central point of the considered graphical item or the point of the considered graphical item nearest to the second position of said graphical item.

Again according to this invention, said first constant value Ω° can be no higher than 90°, preferably no higher than 45°, more preferably no higher than 30° and still more preferably no higher than 22.5°.

Again according to this invention, the method can further include, subsequently to said step C and prior to said step D, the following steps:

J. checking whether the distance between said second position and the starting position is smaller than a threshold distance;

K. when the result of said step J is negative,

defining within said working area a target area for said graphical pointer that is symmetrical with respect to said movement vector,

determining an assembly of selectable graphical items included in said target area,

when said assembly of selectable graphical items is not void, locating a target graphical item among the selectable graphical items of said assembly and moving the graphical pointer to a final position superimposed on said target graphical item;

said method being further characterised in that said steps D, E, F and G are bound to a positive result of said step J.

Further according to this invention, said step K can define the target area for said graphical pointer as a function of the distance between the second position and the starting position, so as to establish a one to one correspondence between a target area and a range of values, included in a group comprising one or more ranges of values, of the distance between the second position and the starting position of said graphical pointer.

Preferably according to this invention, said step K determines said assembly of selectable graphical pointers as the assembly of all selectable graphical pointers included in said target area.

Still according to this invention, the target area defined in said step K can be the intersection of said working area with a circle the centre point of which coincides with the second position of said graphical pointer or with a circle the radius of which is smaller than the distance between the centre point of the circle and the second position of said graphical pointer or with a square.

Again according to this invention, said step K can locate said target graphical item among the graphical items of said assembly as that graphical item whose centre point has minimum distance from the centre point of said target area or as that graphical item having minimum distance from the centre point of said target area.

Preferably, according to this invention, the final position of said graphical pointer coincides with the centre point of the target selectable graphical item.

Further according to this invention, said working area is extended to the whole display screen of the computer.

Preferably according to this invention, the display screen of the computer visualises a Graphical User Interface (GUI) or still more preferably a window GUI.

Still according to this invention, said working area can be a window.

It is further subject-matter of this invention a computer comprising a display screen connected to pointing electro-mechanical means; characterised in that it is adapted to perform the method for moving a graphical pointer as above explained.

Further subject matter of this invention is a computer program characterised in that it includes code means adapted to perform, when they operate on a computer, the method for moving a graphical pointer as above explained.

Still subject-matter of this invention is a memory medium readable by a computer, having a program stored therein, characterised in that said program is the program for computer as above described.

Further particulars and advantages as well as characteristics and construction details will be evident from the following description with reference to enclosed drawings wherein the preferred embodiments are shown by way of illustration and not by way of limitation.

In the drawings:

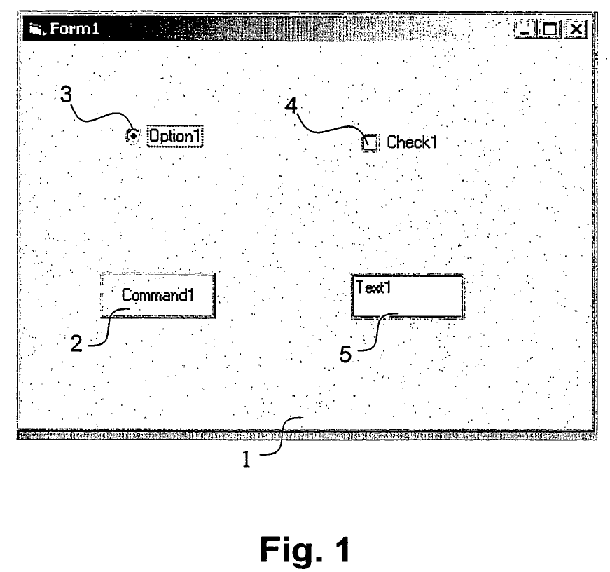

FIG. 1 shows a working area formed by a window of a window GUI;

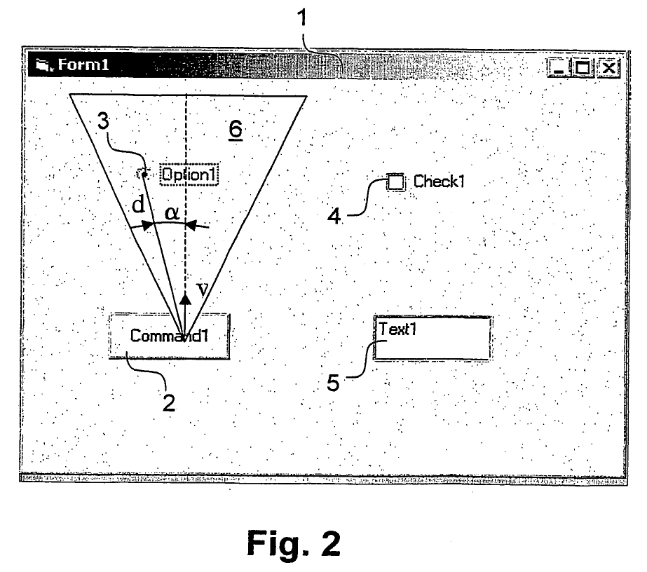

FIG. 2 shows the window of FIG. 1 and a first attraction area of the graphical pointer as defined by a preferred embodiment of the method according to this invention;

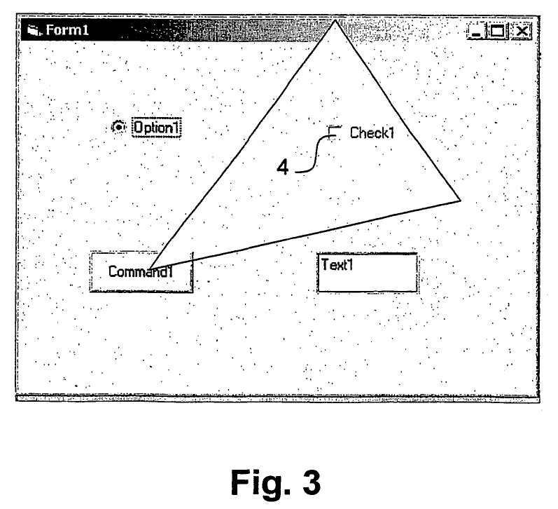

FIG. 3 shows the window of FIG. 1 and a second attraction area of the graphical pointer as defined by a preferred embodiment of the method according to this invention;

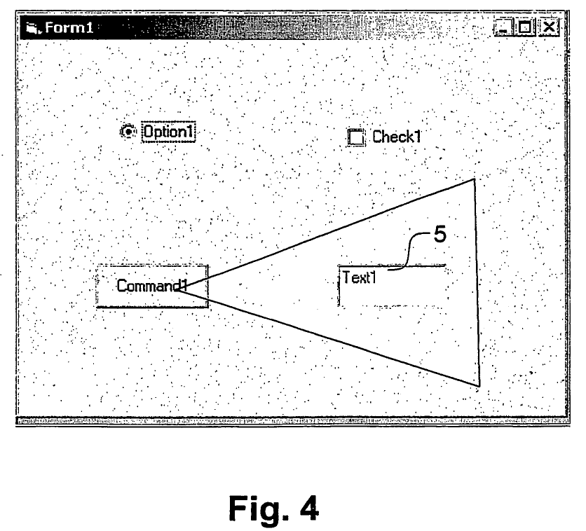

FIG. 4 shows the window of FIG. 1 and a third attraction area of the graphical pointer as defined by a preferred embodiment of the method according to this invention;

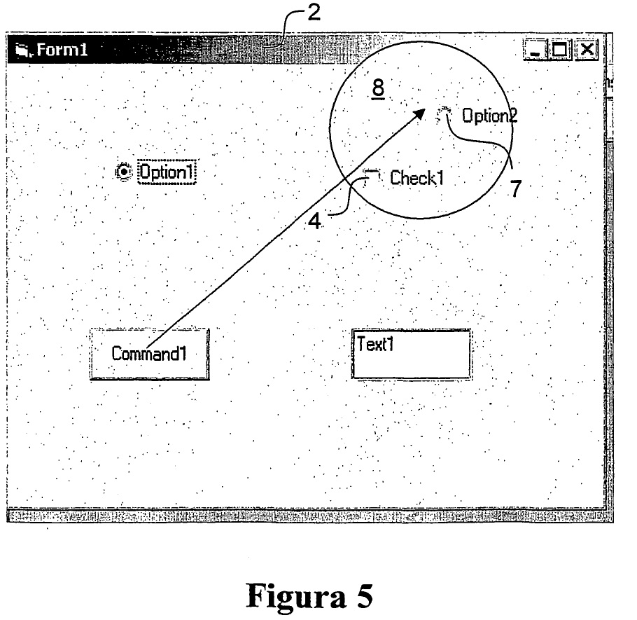

FIG. 5 shows a different working area formed by a window GUI and a target area of the graphical pointer as defined by a preferred embodiment of the method according to this invention; and

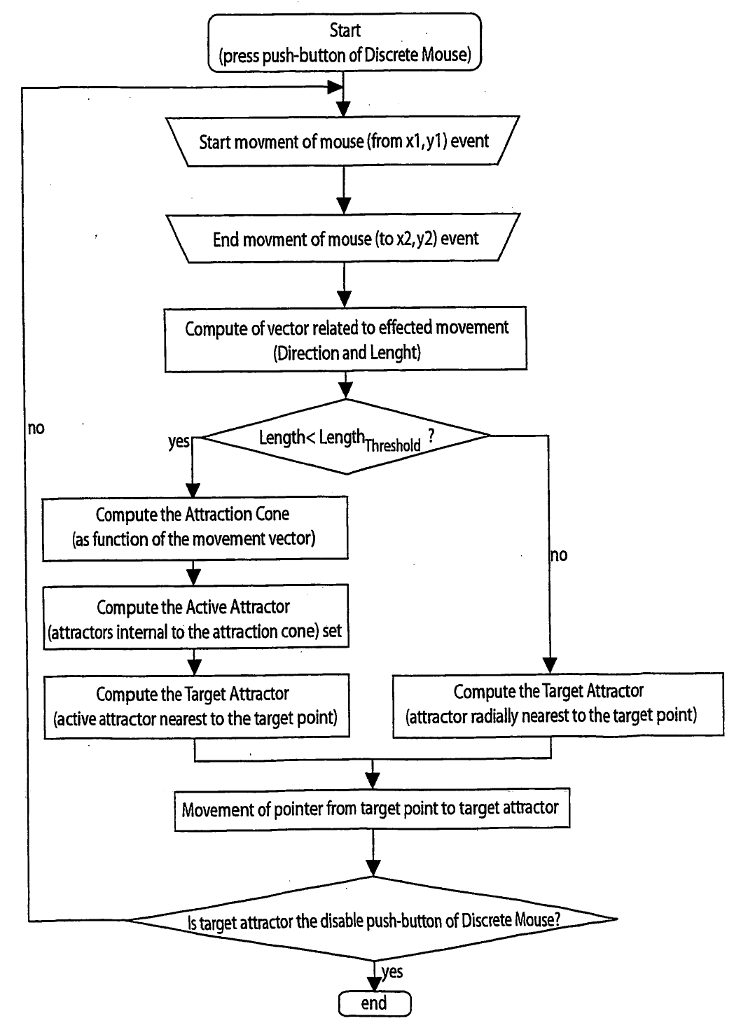

FIG. 6 shows a flow chart that diagrammatically illustrates a preferred embodiment of the method for moving a graphical pointer according to this invention.

In the following description the same reference numerals will be used to designate the same items in the Figures.

Furthermore, only a rotating ball mouse will be considered as an electro-mechanical pointing means in the following description. It should be understood, however, that the method according to this invention and all related instruments and apparatuses can also be applied to pointing electro-mechanical means of other types, such as a trackball or a touch pad or a track point or an infrared mouse or an optical mouse or a foot operated mouse or an Intellimouse.

The method according to this invention allows a different behaviour of the graphical pointer to be obtained, with respect to the conventional displacements proportional to the movements of the mouse, namely proportional to the movement signal generated by the mouse.

In other words, the method according to this invention modifies just the movement linearity of the graphical pointer with respect to the movement of the mouse.

The method does not construe the active window forming the working area of the screen in plain manner. In contrast, it construes the active window as including attraction points for the graphical pointer. An attraction point or attractor is any selectable graphical item of an active window, or any item significantly clickable by the mouse when the graphical pointer is superimposed thereon.

FIG. 1 shows by way of exemplification an active window 1 including a control graphical push-button 2, a first check box 3, a second check box 4 and a text box 5.

According to the method of this invention, the movement of the graphical pointer is no more continuous, but it is a “discrete” movement or, in other words, it is carried out “by jumps”: the concerned graphical pointer moved by jumping form an attraction point to another, according to the movement direction of the mouse.

For a better comprehension of this invention, the operation modes of the preferred embodiments of the method for moving a graphical pointer will be described herein below and it should be understood that similar operation modes apply to other embodiments.

By referring now to FIG. 2, when the graphical pointer, not shown, is superimposed on a graphical push-button 2, assuming that the mouse is moved by a short distance in vertical direction, the method provides for computing a vector v representative of a linear displacement of the graphical pointer, then it defines an attraction area 6 within the active window, which is symmetrical with respect to said vector v, then it determines the assembly of the selectable graphical items included in said area 6 (in the example of FIG. 2, such assembly only includes the first check box 3), then it locates in said assembly a graphical item selectable according to a proximity criterium to the starting positions of the graphical pointer and, lastly, it displaces the concerned graphical pointer to a superimposed position on the so located (in the example of FIG. 2, the first check box 3). Preferably, the short movement of the mouse ought to be no less that a minimum, even more preferably, settable distance Lₘ.

FIG. 2 also evidences the angle α as defined by vector ν and by a long segment d extending between the starting position of the graphical pointer and the central point of the first check box 3. The proximity criterium for locating the selectable graphical item can be the minimum distance d, as above said. Alternatively, the proximity criterium can also take the proximity direction into account and, upon defining a first constant value Q° and a second constant value D, it can also locate the selectable graphical item as the one in connection with which the sum

$$S = \frac{{α}^{°}}{{Ω}^{°}} + \frac{d}{D}$$

takes a minimum value.

In other words, in the example shown in FIG. 2, the graphical pointer will not be displaced upwardly by a short distance, proportionally to the short movement of the mouse in vertical direction, but instead it will lock on the first attractor, namely the check box 3, which lies in the direction of the concerned movement and it will be positioned thereon.

By referring now to FIG. 3, when the mouse is moved by a short distance in upward right side direction, the graphical pointer starts again from a position superimposed on the graphical push-button 2, it locks on the first attractor lying in the direction of this movement, namely the second check box 4, and is positioned thereon.

By observing FIG. 4, when the mouse is moved rightwardly by a short distance, the graphical pointer starts again from a position superimposed on the graphical push-button 2, locks on the first attractor it encounters in the direction of this movement, namely the textbox 5, and is positioned thereon.

In FIG. 24, it can be observed that, according to a preferred embodiment of the method of this invention, the attraction area 6 for the graphical pointer is defined by the intersection of an isosceles triangle with the active window 1.

FIG. 5 shows an active window 2 also including a third check box 7, in addition to the graphical items of window 1. By referring to FIG. 5, it can observed that, according to the preferred embodiment of the method, when a user desires to click on an attractor that is largely spaced from the start point of the graphical pointer and possibly beyond other attractors in the same direction, he will have to displace the mouse by causing it to make a displacement adapted to cause a linear displacement of the graphical pointer greater than a preferably ettable threshold distance Lₛ. In this case, there is not a simple pulse indicating the movement direction, but, instead, there is a path that the graphical pointer ought to follow, arriving at a point close to the attractor. The method defines, within the active window 2, a target area 8 symmetric with respect to the displacement vector of the graphical pointer, then it determines the assembly of selectable graphical items included within the target area 8 (in the example of FIG. 5, such assembly includes the second check box 4 and the third check box 7), locates a selectable graphical item within said assembly according to a proximity criterium with respect to the centre point of the target area 8 and, lastly, it moves the graphical pointer to a position superimposed on the so located graphical item (in the example of FIG. 5, the third check box 7). Preferably, the target area is a circle the center point of which is the final position reached by the graphical pointer at the end of the followed linear path.

Alternatively, the target area could also be a circle not including the starting position of the graphical pointer.

In other embodiments of the method of this invention, the target area can also be different according to the amount of the graphical pointer linear displacement. By way of exemplification, the circular target area could have its centre point in a position as more spaced from the starting position of the graphical pointer as greater is the linear displacement of said graphical pointer.

Preferably, the possible number of the target areas, their morphologies as well as their positions could be configurable by the user.

There are some cases in which the user needs to click on blank areas or on some not-attractor points, for instance when he desires to select a text or to make a different window active.

In this circumstances according to the preferred embodiment of the method, a selectable graphical item, such as a graphical push-button, is provided on the working area of the graphical pointer, in order to enable the activation/deactivation of the method according to this invention.

Alternatively, it is possible to configure a push-button of the mouse, for instance the central or the right one, in order to generate a corresponding signal to activate/deactivate the method according to this invention, preferably in combination with a press action on a dedicated, possibly settable, key of the keyboard.

FIG. 6 shows a flow chart of the preferred embodiment of the method according to this invention, which, based upon the above explanation, ought to be clearly comprehensible to those skilled in the art.

The preferred embodiments of this invention have been described and a number of variations have been suggested hereinbefore, but it should expressly be understood that those skilled in the art can make other variations and changes, without so departing from the scope thereof, as defined by the annexed claims.

1. A method for moving a graphical pointer on a working area of the display screen of a computer, said working area including one or more selectable graphical items, said graphical pointer being controlled by pointing electro-mechanical means adapted to generate at least one control signal for controlling the position and/or the movement of said graphical pointer as well as one or more selection signals and to transmit said signals to said computer, the selection of a graphical item being performed by generating a first selection signal by said pointing electro-mechanical means and being carried out when said graphical pointer is superimposed on said selectable graphical item, the method being characterised in that it includes the following steps:
A. acquiring a displacement start event from at least one control signal generated by said pointing electro-mechanical means;
B. storing a starting position of the graphical pointer on the screen, which coincides with the position taken at the occurrence of said displacement start event;
C. moving said graphical pointer proportionally to said at least one control signal generated by said pointing electro-mechanical means, storing a second position of said graphic pointer on said screen, and calculating a vector representing the displacement of said graphic pointer on the screen from said starting position to said second position;
D. defining, within said within said working area, an attraction area for the graphic pointer that is symmetrical with respect said displacement vector;
E. determining an assembly of selectable graphic items included in said attraction area;
F. checking that said assembly of selectable graphic items is not void;
G. when the result of said step F is positive, locating a target graphic item among the selectable graphic items of said assembly, according to a geometric proximity criterium to said second position of the graphic pointer, and moving said graphic pointer to a final position superimposed on said target graphic item; and
H. returning to performing said step a.

2. A method according to claim 1, characterised in that said step C. includes the following sub-steps in the following order:
C1.1. acquiring a displacement end event from at least one control signal generated by said pointing electro-mechanical means;
C1.2. storing the second position of the graphical pointer on the screen as the one coinciding with the position taken at the occurrence of said displacement end event; and
C1.3. computing the vector representative of the displacement of the graphical pointer on the screen from the initial position to the second position.

3. A method according to claim 2, characterised in that said step C also includes the following sub-steps in the following order:
C1.4. checking whether the distance between said second position and said initial position is smaller than a minimum distance, and
C1.5. when the result of sub-step C1.4 is positive, return to performing step A.

4. A method according to claim 3, characterised in that said sub-step C1.4 is subsequent to said sub-step C1.3.

5. A method according to claim 3, characterised in that said sub-step C1.4 is subsequent to said sub-step C1.2 and said sub-step C1.3 is subsequent to said sub-step C1.5.

6. A method according to claim 1, characterised in that said step C also includes the following sub-steps in the following order:
C2.1. allowing an inactivity pause to elapse;
C2.2. storing a current position of the graphical pointer on the screen, that coincides with the position taken at the end of said pause;
C2.3. checking whether the distance between the current position and the starting position is smaller than a minimum distance;
C2.4. when the result of said sub-step C2.3 is positive, checking said at least one control signal generated by said pointing electro-mechanical means, and, when said at least one control signal corresponds to a movement of said graphical pointer, returning to performing said sub-step C2.1, or, when said at least one control signal does not correspond to a movement of said graphical pointer, returning to performing said step A,
C2.5. when the result of said sub-step C2.3 is negative, storing said second position of the graphical pointer on the screen as the one coinciding with the current position, said step C also including the following sub-step:
C2.6. computing the vector representative of the displacement of the graphical pointer on the screen from the starting position to the second position.

7. A method according to claim 6, characterised in that said sub-step C2.6 is subsequent to said sub-steps C2.4 and C2.5.

8. A method according to claim 6, characterised in that said sub-step C2.6 is subsequent to said sub-step C2.2 and precedent to said sub-step C2.3.

9. A method according to any one of the preceding claims, characterised in that the attraction area for the graphical pointer as defined in said step D is included within a planar angle having a width no greater than 180°, the apex of which coincides with the starting position of the graphical pointer and the bisecting line of which lies on the vector representative of the displacement of said graphical pointer.

10. A method according to claim 9, characterised in that said planar angle has a width no greater than 90°.

11. A method according to claim 10, characterised in that said planar angle has a width no greater than 60°.

12. A method according to claim 11, characterised in that said planar angle has a width no greater than 45°.

13. A method according to any one of claims 9 to 12, characterised in that the attraction area for said graphical pointer as defined in step D is furnished by the intersection of an isosceles triangle with said working area.

14. A method according to any one of claims 9 to 12, characterised in that the attraction area for said graphical pointer as defined in step D is furnished by the intersection of a circular sector with said working area.

15. A method according to any one of claims 9 to 12, characterized in that the attraction area for said graphical pointer as defined in step D is furnished by the intersection of said planar angle with said working area.

16. A method according to any one of claims 9 to 15, characterised in that said step E determines said assembly of selectable graphical items as the assembly of all selectable graphical items included in said working area.

17. A method according to any one of claims 9 to 16, characterised in that said step G locates said target graphical item among the graphical items of said assembly as that graphical item having minimum distance from said second position of the graphical item.

18. A method according to any one of claims 9 to 16, characterised in that said step G includes the following sub-steps:
G2.1. for each selectable graphical item included in said assembly,
determining the point of said selectable graphical item nearest to the second position of said graphical pointer, and
calculating the distance of said point nearest to the second position of the graphical pointer;
G2.2. locating said target graphical item among the graphical items of said assembly as that graphical item having minimum distance as calculated in said sub-step G2.1.

19. A method according to any one of claims 9 to 16, characterised in that said step G includes the following sub-steps:
G3.1. for each selectable graphical item included in said assembly,
calculating a connection vector that starts from the initial position of the graphical pointer and arrives at a point of the considered graphical item,
calculating the absolute value α° of the width of the angle defined by the vector representing the displacement of said graphical pointer and by said connection vector,
calculating a first ratio α°/Ω° between said absolute value α° and a first constant value Ω°,
calculating the distance d of said point from the second position of said graphical pointer,
calculating a second ratio d/D between said distance d and a second constant value D,
calculating the sum
$$S = \frac{{α}^{°}}{{Ω}^{°}} + \frac{d}{D}$$
of said first ratio and said second ratio,
G3.2. locating said target graphical item among the graphical items of said assembly as that graphical item having minimum sum S as calculated in said sub-step G3.1.

20. A method according to claim 19, characterised in that the arrival point of said connection vector as calculated in said sub-step G3.1 is the central point of the considered graphical item.

21. A method according to claim 19, characterised in that the arrival point of said connection vector as calculated in said sub-step G3.1 is the point of the considered graphical item nearest to the second position of said graphical item.

22. A method according to any one of claims 9 to 16, characterised in that said first constant value Ω° is no higher than 90°.

23. A method according to claim 22, characterised in that said first constant value Ω° is no higher than 45°.

24. A method according to claim 23, characterised in that said first constant value Ω° is no higher than 30°.

25. A method according to claim 24, characterised in that said first constant value Ω° is no higher than 22.5°.

26. A method according to any one of claims 2 to 16, characterised in that it further includes, subsequently to said step C and prior to said step D, the following steps:
J. checking whether the distance between said second position and the starting position is smaller than a threshold distance;
K when the result of said step J is negative,
defining within said working area a target area for said graphical pointer that is symmetrical with respect to said movement vector,
determining an assembly of selectable graphical items included in said target area,
when said assembly of selectable graphical items is not void, locating a target graphical item among the selectable graphical items of said assembly and moving the graphical pointer to a final position superimposed on said target graphical item;
said method being further characterised in that said steps D, E, F and G are bound to a positive result of said step J.

27. A method according to claim 26, characterised in that said step K defines the target area for said graphical pointer as a function of the distance between the second position and the starting position, so as to establish a one to one correspondence between a target area and a range of values, included in a group comprising one or more ranges of values, of the distance between the second position and the starting position of said graphical pointer.

28. A method according to claim 26 or 27, characterised in that said step K determines said assembly of selectable graphical pointers as the assembly of all selectable graphical pointers included in said target area.

29. A method according to any one of claims 26 to 28, characterised in that the target area defined in said step K is the intersection of said working area with a circle the centre point of which coincides with the second position of said graphical pointer.

30. A method according to any one of claims 26 to 28, characterised in that the target area defined in said step K is the intersection of said working area with a circle the radius of which is smaller than the distance between the centre point of the circle and the second position of said graphical pointer.

31. A method according to any one of claims 26 to 28, characterised in that the target area defined in said step K is the intersection of said working area with a square.

32. A method according to any one of claims 29 to 31, characterised in that said step K locates said target graphical item among the graphical items of said assembly as that graphical item whose centre point has minimum distance from the centre point of said target area.

33. A method according to any one of claims 29 to 31, characterised in that said step K locates said target graphical item among the graphical items of said assembly as that graphical item having minimum distance from the centre point of said target area.

34. A method according to any one of the preceding claims, characterised in that the final position of said graphical pointer coincides with the centre point of the target selectable graphical item.

35. A method according to any one of the preceding claims, characterised in that said working area includes a selectable graphical item for a method enable/disable function.

36. A method according to any one of the preceding claims, characterised in that said working area is extended to the whole display screen of the computer.

37. A method according to any one of the preceding claims, characterised in that the display screen of the computer visualises a Graphical User Interface (GUI).

38. A method according to claim 37, characterised in that said GUI is a window GUI.

39. A method according to claim 38, characterised in that said working area is a window.

40. A method according to any one of the preceding claims, characterised in that said pointing electro-mechanical means comprise a roller-ball mouse or a trackball or a touch pad or a track point or an infrared mouse or a tailless mouse or an optical mouse or a foot controlled mouse or an upper wheel mouse or an Intellimouse.

41. A method according to any one of the preceding claims, characterised in that said pointing electro-mechanical means generate any selection signal by a press action on a corresponding push-button.

42. A computer comprising a display screen connected to pointing electro-mechanical means, characterised in that it is adapted to perform the method for moving a graphical pointer according to any one of the preceding claims 1 to 41.

43. A computer program characterised in that it includes code means adapted to perform, when they operate on a computer, the method for moving a graphical pointer according to any one of the preceding claims 1 to 41.

44. A memory medium readable by a computer, having a program stored therein, characterised in that said program is the program for computer according to claim 43.
